(19) United States
(12) Patent Application Publication
(10) Pub. No.: US 2024/0109002 A1
(43) Pub. Date: Apr. 4, 2024

(54) LIQUID-GAS SEPARATION USING MULTIPLE INLET NOZZLES

(71) Applicant: Dryline Technologies LP, Katy, TX (US)

(72) Inventors: Michael Edmund Fisher, Houston, TX (US); Nelson Simoes dos Santos, Houston, TX (US)

(21) Appl. No.: 17/960,128

(22) Filed: Oct. 4, 2022

(51) Int. Cl. B01D 5/00; B01D 53/00

(52) U.S. Cl. CPC B01D 5/0054; B01D 5/0081; B01D 53/002

(57) ABSTRACT

Embodiments presented provide a compressed air and liquid separator having a shell adapted to be vertically or horizontally oriented in use. The shell has an inlet end and an outlet end and defines a separating chamber therein. An inlet plate is coupled to the inlet end of the shell and provides a compressed gas ingress into the separating chamber, the compressed gas including a liquid therein. A plurality of inlet nozzles is disposed in the inlet plate, each inlet nozzle having an inner diameter and a length that are selected so as to accelerate the compressed gas therethrough to below a dew point thereof. A plurality of separating baffles positioned within the separating chamber above the compressed gas ingress, the separating baffles providing a means for separating the liquid from the compressed gas. An outlet plate is coupled to the outlet end of the shell, the outlet plate providing a compressed gas egress out of the separating chamber.

### CROSS-REFERENCE TO RELATED APPLICATIONS

None.

### FIELD OF THE DISCLOSURE

Embodiments of the present disclosure relate to apparatuses and methods for separating liquid from a stream of gas and, more particularly, to an apparatus and method for separating liquid from a gas stream in which multiple nozzles are provided for intake of the gas stream.

### BACKGROUND

This section of this document introduces various information from the art that may be related to or provide context for some aspects of the subject matter described herein and/or claimed below. It provides background information to facilitate a better understanding of that which is disclosed and claimed herein. As such, this is a discussion of “related” art. That such art is related in no way implies that it is also “prior” art. The related art may or may not be prior art. The discussion in this section is to be read in this light, and not as admissions of prior art.

Effective removal of liquid from a stream or flow of gas is important in many applications. The presence of liquid in a stream of compressed air, for example, can cause problems to downstream equipment, such as compressors, turbines, and the like. As another example, hydrocarbons extracted from the ground typically contain a mixture of liquids, gasses, and particulates, known as “free liquids.” Such free liquids include water, brine, kerosene, oils, condensate, ethylene glycol (“MEG”), drilling fluids, and the like. The production stream may also include particulates, such as sand or other sediments.

The production stream moves under pressure through a series of lines for collection and processing. The production stream may encounter a variety of equipment in the course of its movement that serve one purpose or another. Different components of equipment of different types may be utilized depending on the end use of the production stream. Over time, the free liquids and particulates can accumulate on the equipment to a point where repair or replacement of one or more components of the equipment may be needed.

The presently disclosed technique is directed to resolving, or at least reducing, one or all of the problems mentioned above. Even if acceptable solutions are available to the art to address these issues, the art is always receptive to improvements or alternative means, methods, and configurations. Thus, there exists a need for a technique such as that disclosed and claimed herein.

### SUMMARY

So that the manner in which the features aspects of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one aspect, embodiments of the present disclosure relate to a liquid and gas separator. The gas separator comprises a shell adapted to be vertically or horizontally oriented in use, the shell having an inlet end and an outlet end and defining a separating chamber therein. The gas separator also comprises an inlet plate coupled to the inlet end of the shell, the inlet plate providing a compressed gas ingress for receiving a flow of compressed gas into the separating chamber, the compressed gas including a liquid therein. The gas separator further comprises a plurality of inlet nozzles disposed in the inlet plate, each inlet nozzle having an inner diameter and a length that are selected so as to accelerate the flow of compressed gas to or below a dew point thereof. The gas separator still further comprises one or more separating baffles positioned within the separating chamber above the compressed gas ingress, the one or more separating baffles providing a means for separating the liquid from the compressed gas. An outlet plate is coupled to the outlet end of the shell, the outlet plate providing a compressed gas egress out of the separating chamber.

In another aspect, embodiments of the present disclosure relate to a method of separating liquid from a gas stream. The method comprises providing a shell adapted to be vertically or horizontally oriented in use, the shell having an inlet end and an outlet end and defining a separating chamber therein. The method also comprises receiving a flow of compressed gas into the separating chamber through a compressed gas ingress at the inlet end of the shell, the compressed gas including a liquid therein. The method further comprises accelerating the flow of compressed gas through a plurality of inlet nozzles disposed at the compressed gas ingress, each inlet nozzle having an inner diameter and a length that are selected so as to accelerate the flow of compressed gas therethrough to or below a dew point thereof. The method still further comprises separating the liquid from the compressed gas at one or more separating baffles positioned within the separating chamber above the compressed gas ingress, and providing a compressed gas egress out of the separating chamber at the outlet end of the shell.

In yet another aspect, embodiments of the present disclosure relate to a multi-nozzle plate configured to provide an inlet for a compressed gas and liquid separator. The plate comprises a first inlet nozzle disposed in the plate for receiving a flow of compressed gas, the compressed gas including a liquid therein, the first inlet nozzle having an inner diameter and a length that are selected so as to accelerate the flow of compressed gas to or below a dew point thereof. The plate also comprises at least one additional inlet nozzle disposed in the plate for receiving the compressed gas, each of the at least one additional inlet nozzle having an inner diameter and a length that are selected so as to accelerate the flow of compressed gas to or below the dew point thereof. The flow of compressed gas subsequently decelerates and expands after exiting the first inlet nozzle and the at least one additional inlet nozzle.

The above presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

### BRIEF DESCRIPTION OF THE DRAWINGS

The invention may be understood by reference to the following description taken in conjunction with the accompanying drawings, in which like reference numerals identify like elements.

FIG. 1 is a schematic diagram illustrating a separator having multiple inlet nozzles in accordance with embodiments of the present disclosure.

FIGS. 2A-2C are schematic diagrams illustrating various views of a multi-nozzle inlet plate in accordance with embodiments of the present disclosure.

FIGS. 3A and 3B are schematic diagrams illustrating an alternative multi-nozzle inlet plate in accordance with embodiments of the present disclosure.

FIG. 4 is a schematic diagram illustrating an alternative separator that uses the multi-nozzle inlet plate of FIGS. 3A and 3B in accordance with embodiments of the present disclosure.

FIG. 5 is a schematic diagram illustrating another alternative multi-nozzle inlet plate in accordance with embodiments of the present disclosure.

FIG. 6 is a schematic diagram illustrating adiabatically and isentropically acceleration of a gas in accordance with embodiments of the present disclosure.

FIG. 7 is a flowchart illustrating a method that may be used with a separator having multiple inlet nozzles in accordance with embodiments of the present disclosure.

To facilitate understanding, identical reference numerals or similar have been used, where possible, to designate identical elements that are common to the figures (“FIGS.”). It is contemplated that elements disclosed in one embodiment may be beneficially utilized with other embodiments without specific recitation of such elements.

### DETAILED DESCRIPTION

Illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The subject matter claimed below will now be described with reference to the attached figures. Various structures, systems and devices are schematically depicted in the drawings for purposes of explanation only and so as to not obscure the claimed subject matter with details that are well known to those skilled in the art. Nevertheless, the attached drawings are included to describe and explain illustrative examples shown therein.

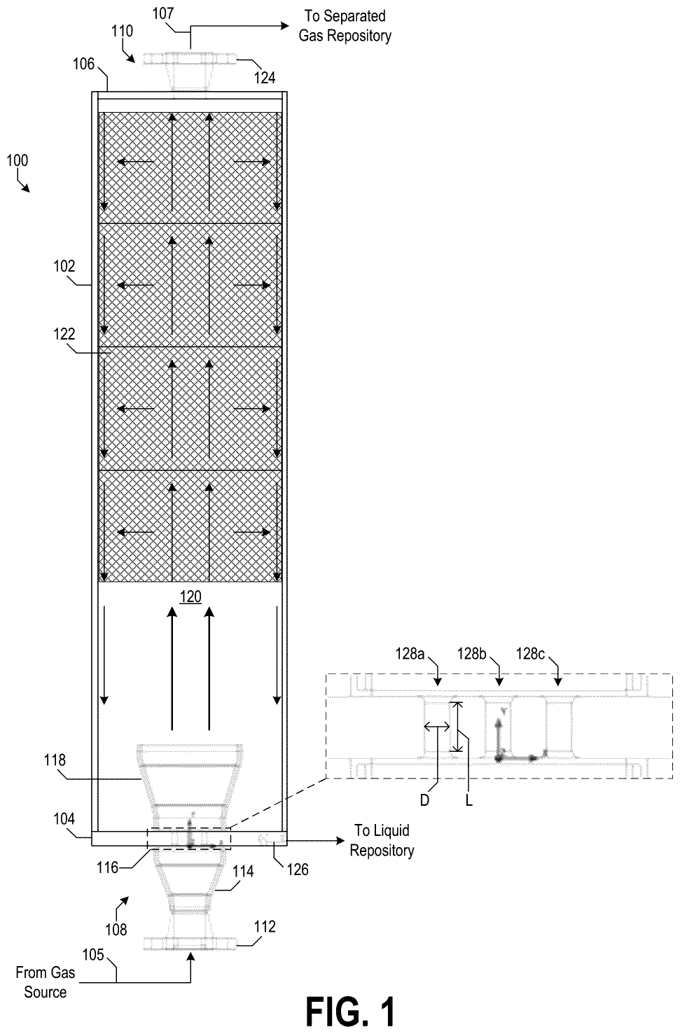

Referring to FIG. 1, a liquid-gas separator 100 is shown for separating liquid from a stream or flow of gas, such as saturated compressed air, in accordance with embodiments of the present disclosure. The separator 100 includes a generally cylindrical, hollow main body or shell 102 having an inlet plate 104 covering one end (the inlet end) and an outlet plate 106 covering an opposite end (the outlet end). The separator 100 is shown installed on or coupled to a gas source line 105 from a source of wet gas, such as a saturated air source. For example, the gas source line 105 may be part of an automotive compressed air source, or a hydrocarbon wellhead, or some other gas source not expressly shown. An inlet assembly 108 mechanically couples the gas source line 105 to the separator 100. At the opposite end, the separator 100 is installed on or coupled to a gas repository line 107 leading to a gas repository, such as a compressed air tank or a natural gas tank, or some other gas repository not expressly shown. An outlet assembly 110 mechanically couples the gas repository line 107 to the separator 100.

In basic operation, saturated gas is pumped or otherwise provided into the separator 100 through the inlet plate 104. The stream of gas passes into the interior of the separator 100 where liquid and gas are separated from one another in a manner that will be explained below. Any particulates are likewise separated from the gas at this time. The separated gas continues moving through the separator 100 toward the outlet plate 106 where it exits the separator 100. The liquid (and any particulates), now also separated, is pushed or otherwise directed radially outward toward the shell 102 of the separator 100 where the liquid naturally flows down the interior wall of the shell 102 toward the bottom of the separator 100 for drainage and removal. Indeed, the separator 100 may be used in a vertical orientation or in an inclined orientation where the separator 100 is nearly horizontal (e.g., about 15 degrees above horizontal). The separator 100 itself also does not require electrical power for operation. Liquid-gas separation is performed passively as saturated gas is pumped into the separator 100 via the gas source line 105.

More specifically, the saturated gas is provided through the gas source line 105 under pressure (e.g., 100 psi) from an external source. This pressurized gas flows into the separator 100 through the inlet assembly 108. The separator 100 can be adapted as needed to accommodate different levels of pressure at the inlet assembly 108. The inlet assembly 108, in some embodiments, is composed of a weld neck flange 112 (e.g., 2-in., RF 150 weld neck flange) mechanically coupled to a concentric reducer 114 (e.g., 5 in.×2 in. concentric reducer). From the inlet assembly 108, the saturated gas passes through a set of inlet nozzles, indicated generally at 116, that have been formed or otherwise provided in the inlet plate 104. The inlet nozzles in the set 116 accelerate the flow of gas into a divider cone 118 where the gas expands and slows down before entering a separation chamber 120. The divider cone 118 also helps to keep the saturated gas entering the separation chamber segregated from the separated liquid draining along the interior wall of the shell 102.

Within the separation chamber 120, the liquid (and any particulates) are separated from the gas by one or more permeable barriers 122, also known as “separating baffles.” The one or more separating baffles 122 are made of a mesh like material that provides a surface for the liquid (and any particulates) in the saturated gas to condense upon, in some embodiments. The thusly separated liquid (and any particulates) are then drawn radially outward toward the shell 102 of the separator 100 and along the interior wall of the shell 102, indicated by the side and downward arrows. A side drain 126 is provided in the inlet plate 104 near or adjacent to the shell 102 to collect the separated liquid (and any particulates) for removal out the side of the inlet plate 104. Meanwhile, the separated gas continues upward through the separation chamber 120 toward the outlet plate 106, as indicated by the upward arrows, and exits through the outlet assembly 110. In some embodiments, the outlet assembly 110 may be composed of a similar weld neck flange 124 as the inlet assembly 108.

In accordance with embodiments of the present disclosure, the use of a set 116 of inlet nozzles in the inlet plate 104 provides a number of advantages over existing solutions. In the example of FIG. 1, there are four inlet nozzles in the set 116, although only three are visible in the figure, indicated at 128a, 128b, 128c. Existing liquid-gas separators, such as described in International Application No. PCT/US2021/033354, which is incorporated herein by reference, typically use a single inlet nozzle. The present inventors have discovered that by flowing incoming saturated gas through multiple nozzles as described herein, a higher gas flow rate and improved liquid-gas separation are achieved. Within the nozzles, the gas stream is accelerated and a condition of lower pressure and temperature is established per the Ideal Gas Laws (i.e., Charles's law), which causes the temperature of the saturated gas to drop to or below its dew point. This drop in temperature helps precipitate moisture droplets from the saturated gas stream, which fosters formation of fog. The moisture droplets/fog then exit the nozzles and immediately flow into the larger divider cone 118 and expansion chamber 120, where the gas stream decelerates and the velocity drops. The decrease in velocity increases the contact time between the moisture droplets/fog and the one or more mesh-like separating baffles 122 in the chamber 120. The prolonged moisture-to-mesh contact increases the moisture droplet size, which facilitates formation of larger droplets and precipitation of the droplets along the wall of the expansion chamber 120.

In the FIG. 1 example, each of the nozzles 128a-c resembles a generally cylindrical, open-ended tube defining a generally uniform pathway therethrough for gas to flow. The pathway for each nozzle 128a-c has an inner diameter (D) and a length (L), with a tapered or beveled opening on opposite ends thereof. The present inventors have discovered that when the ratio of the inner diameter (D) over the length (L) falls within a certain range of values for a given saturated gas under a given pressure, this produces optimal conditions for the temperature of the saturated gas flowing through the nozzles 128 to drop to or below its dew point temperature without overly restricting flow. This ratio, sometimes referred to as the dew point temperature ratio, may range from about 0.25 (e.g., diameter/length of ¼ in./1.0 in.) to about 0.75 (e.g., diameter/length of ¾ in./1.0 in.), and is preferably about 0.375 (e.g., diameter/length of 0.3/8 in./1.0 in.) to about 0.625 (e.g., diameter/length of ¾ in./1.0 in.) for a given saturated gas under a given pressure upon entering the inlet nozzles 128a-c, depending on the requirements of the particular separation application. By adjusting the pathway diameter (D) and length (L) for the nozzles 128a-c so that the length (L) is maximized within the dew point temperature ratio for a given saturated gas under a given pressure, improved liquid-gas separation is achieved for the application. In addition, by adjusting the number of inlet nozzles 128a-c (e.g., two, three, four, five, six, seven, eight, etc.) in view of their diameters, improved overall flow rate may be achieved for the application.

In the example, depending on the particular application, the saturated gas carried by the line 105 may be a saturated gas feedstock, such as compressed air, natural gas or other hydrocarbons. The saturated gas feedstock may contain free liquids and particulates in the form of at least one of a plurality of gaseous mixtures, a plurality of condensable vapors, and a liquid, none of which as separately shown. While it is possible to have a liquid at the ingress, a dual phase flow stream (or three phase for solid particulates) is not necessary at the ingress.

The shell 102 may be a Schedule 20 (or higher) pipe having a 12-in. diameter made of SAE 304 stainless steel or similar corrosion resistant material that can withstand the temperatures and pressures expected to be present within the shell 102. Other pipe schedules may also be used depending on the requirements of the particular application. In general, the pipe inner diameters are selected based on the flow rate requirements (CFM) for a given application and may range anywhere from a 2-in. pipe to a 16-in pipe. Similarly, other materials beside stainless steel may be used, such as aluminum, where a high flow rate is not needed for the application. The pipes generally define a uniform interior that extends along their entire lengths, although it is possible to have a slightly conical interior in which the inlet end of the shell 102 has a smaller diameter than the outlet end in some embodiments, to facilitate flow of separated liquid toward the side drain 126. Couplings and other attachments to the shell 102 may be accomplished via full pen welds, threaded fasteners, or other suitable fastening techniques.

The one or more separating baffles 122 may take the form of “mist pads” constructed of a woven mesh material wound about a central point. One or more rolls of these mist pads may then be inserted into separation chamber 120 within the shell 102 to be used as the separating baffles 122. Such mist pads are commercially available in strips or preformed rolls made of a metal, plastic, ceramic, or other corrosion resistant material. Mesh having different size pores or openings may be used depending on the particular application, such as a 0.011-in. bulk mesh. Rolls of mesh may then be stacked on top of one another as needed and held in place by friction, epoxy, adhesive, and/or welding to form the one or more separating baffles 122. In FIG. 1, an exemplary shell 102 having a length of 24 inches would preferably have enough rolls of mist pads to provide separating baffles 122 starting at or near the outlet plate 106 down to the divider cone 118 (e.g., about 20 inches in some embodiments).

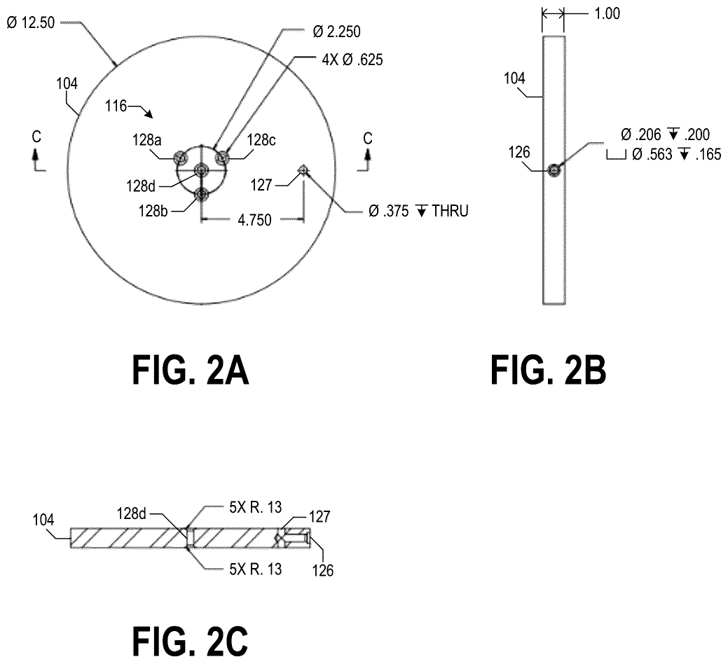

Turning now to FIGS. 2A-2C, different views of the exemplary inlet plate 104 showing the set 116 of exemplary nozzles are shown. FIG. 2A shows a plan view of the inlet plate 104, FIG. 2B shows a side view of the plate 104, and FIG. 2C shows a cross-sectional view of the inlet plate 104 along line C-C from FIG. 2A. Exemplary dimensions are provided here (and throughout this description) for illustrative purposes only and alternative dimensions may be used within the scope of the present disclosure.

As can be seen, the inlet plate 104 has a set 116 of nozzles that includes four nozzles 128a, 128b, 128c, 128d. Three of the inlet nozzles 128a-c are equally spaced around a center axis of the inlet plate 104 along a 2.250-in. diameter circle, while the fourth inlet nozzle 128d is located on the center axis of the plate 104. Of course, the nozzles 128a-d need not be evenly spaced about the inlet plate 104 and may be asymmetrically located in some embodiments. Each inlet nozzle 128a-d has a 0.625-in. diameter (D) and a 1.0-in. length (L) in this example. The particular combination of diameter (D) and length (L) may vary and may be selected as needed according to the needs of the application. Thus, for a given diameter (D), a longer length (L) may be selected to allow the separator to accommodate a reduced pressure (psi) requirement, such as found in paint shops, air knives, and similar applications. Conversely, for a given length (L), a larger diameter (D) may be used to improve flow rate (CFM) where the pressure of the incoming saturated gas is more than sufficiently high. Similarly, the number of nozzles having a given diameter (D) and length (L) may be increased or decreased to improve or lower flow rate as needed.

Also visible here is a drain hole 127 provided on a face of the inlet plate 104 that is plumbed to the side drain 126 in the side of the inlet plate 104 for removing separated liquid. The inlet plate 104 itself is a 1-in thick SAE 304 stainless steel plate in this example. The use of such a multi-nozzle inlet plate 104 in a separator such as the separator 100, can significantly improve liquid-gas separation, as described above. Alternatively, a drain may be plumbed through the inlet plate 104 so that separated liquid exits out the opposite (bottom) side of the inlet plate 104.

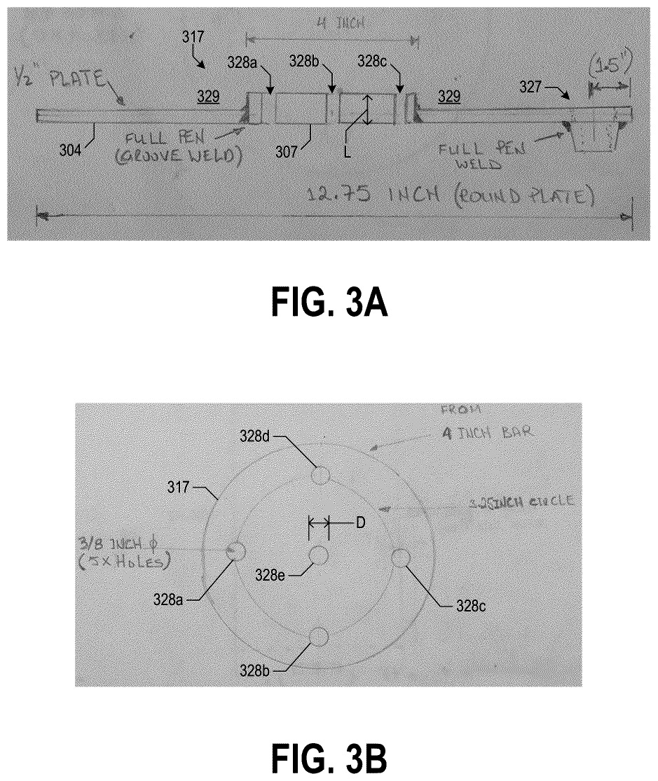

FIGS. 3A and 3B illustrate an exemplary alternative inlet plate 304 in accordance with embodiments of the present disclosure. FIG. 3A is a cross-sectional side view of the inlet plate 304 in which a multi-nozzle 317 has been mounted in the plate 304, and FIG. 3B is a plan view of the multi-nozzle 317. As before, exemplary dimensions are provided for illustrative purposes only and do not limit the scope of the present disclosure. In this alternative embodiment, the inlet plate 304 is a separate component to which the multi-nozzle 317 can be fitted. This allows the same inlet plate 304 to be used with different variations of the multi-nozzle 317. Moreover, the multi-nozzle 317 can be made substantially thicker (e.g., 1.5×, 2×, 2.5×, 3×, 3.5×, etc.) than the inlet plate 304 in some embodiments so that an annular moat, indicated generally at 329, is formed around the multi-nozzle 317. The annular moat 329 produces a similar effect on gas exiting the multi-nozzle 317 as the divider cone 118 (i.e., expands and slows down gas exiting from the multi-nozzle), such that a separate divider cone 118 is not needed and may be omitted in some embodiments.

The multi-nozzle 317 in this embodiment has five inlet nozzles 328a, 328b, 328c, 328d, 328e. Four of the inlet nozzles 328a-d are equally spaced apart along a 3.25-in. diameter circle around a center axis of the multi-nozzle 317, while the fifth inlet nozzle 328e is located on the center axis of the multi-nozzle 317. However, it is not necessary for the nozzles 128a-d to be evenly spaced about the inlet plate 304 and an alternative, asymmetrical nozzle arrangement may be used in some embodiments. Each of the nozzles 328a-d has a 0.375-in. diameter (D) and a 1-in length (L) in this embodiment. The multi-nozzle 317 itself may have a 3-in. diameter and a 1.0-in. thickness, while the inlet plate 304 has a 0.5-in. thickness in this embodiment. A drain hole 327 is provided in the inlet plate 304 for removal of separated liquid.

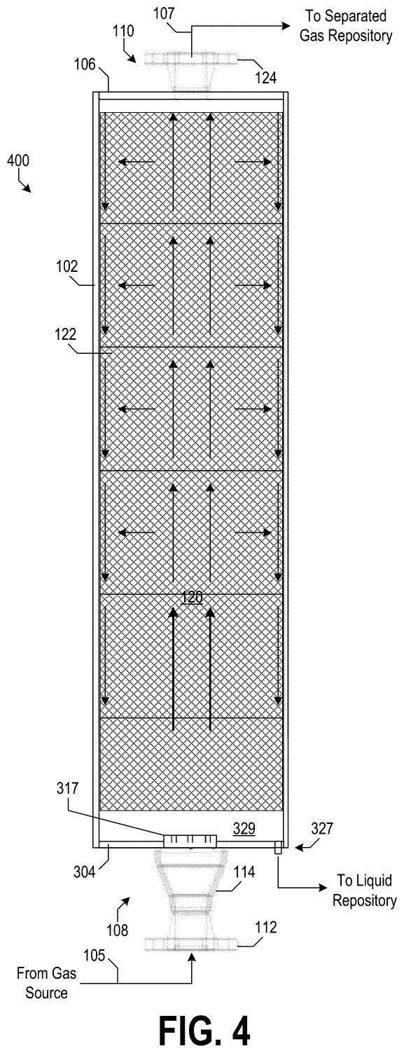

FIG. 4 illustrates an exemplary liquid-gas separator 400 that uses the alternative inlet plate 304 and multi-nozzle 317 from FIGS. 3A and 3B. The separator 400 is similar to its counterpart separator 100 from FIG. 1 insofar as there is a generally tubular, hollow shell 102 installed on or coupled to a gas source line 105. An inlet assembly 108 mechanically couples the gas source line 105 to the separator 400, while an outlet assembly 110 mechanically couples a gas repository line 107 to the separator 400. The shell 102 defines a separation chamber 120 containing one or more mesh-like separation baffles 122 that extend down near the multi-nozzle 317. Note that the separator 400 does not include an inlet plate or a divider cone like the separator 100 from FIG. 1 does. Instead, the separator 400 uses the inlet plate 304 and the multi-nozzle 317 described above. As explained, the multi-nozzle 317 can have a greater thickness than the inlet plate 304 in some embodiments so that a moat 329 is defined around the inlet plate 304, which produces a similar effect as the divider cone on the flow of gas exiting the multi-nozzle 317. Basic operation of the separator 400 is similar to basic operation of the separator 100 and therefore a detailed description is omitted here for economy.

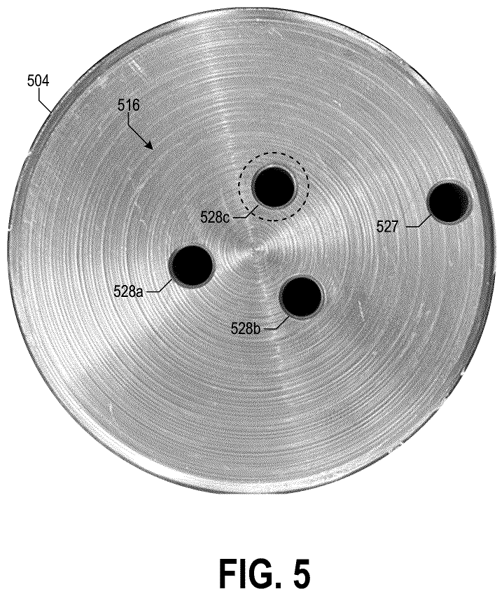

FIG. 5 is a schematic diagram illustrating another alternative multi-nozzle inlet plate 504 in accordance with embodiments of the present disclosure. In this version, the inlet plate 504 has three inlet nozzles 528a, 528b, 528c in the set 516 of inlet nozzles, all symmetrically arranged about a center axis of the plate 504. A drain hole 527 is again formed in the inlet plate 504 for removal of separated liquid. Note that the third inlet nozzle 528c is enclosed within a dashed circle to indicate that this nozzle is optional in some embodiments, in which case the first and second inlet nozzles 528a, 528b may be arranged either as shown in the figure or directly opposite to one another.

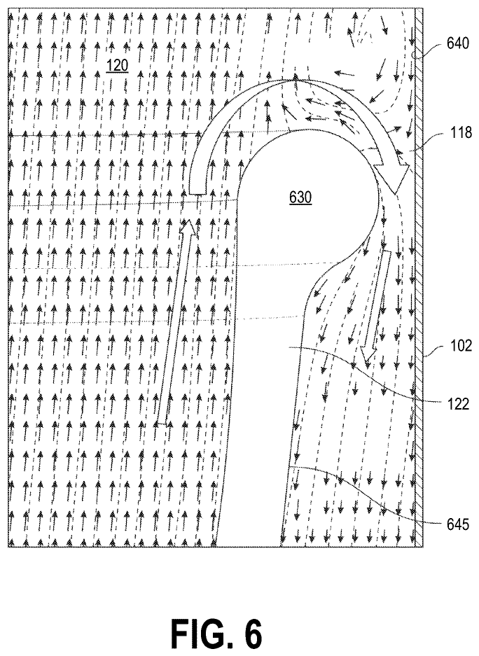

Turning now to FIG. 6, a close-up cross-sectional view of a tip a portion 630 of the divider cone 118 discussed previously is shown. Saturated gas flowing past the tip portion 630 of the divider cone 118 causes a pressure drop in an annular area 635 between the tip portion 630 (i.e., the “exit” of the divider cone 118) and an inner diameter 640 of the shell 102 in the separation chamber 120. In FIG. 6, the arrows represent fluid flow and their density represents pressure. Thus, a greater concentration of arrows represents a higher pressure and a lower concentration represents a lower pressure. The pressure drop draws the liquid or condensed vapors to the egress of the divider cone 118. For instance, if there is a solid precipitate (e.g., ice) deposition in the flow stream, it will naturally follow this path, but not as a liquid. In some embodiments, the nozzle tip 630 is close enough to the inner diameter 640 of the shell 102 to create a vacuum in the annular egress area, i.e., the annular area 635. Note that the slope of an outer surface 645 of the divider cone nozzle 122 away from the inner diameter 640 may influence the magnitude of the pressure drop.

Furthermore, as discussed earlier, the inlet nozzles act to accelerate the saturated gas passing therethrough into the divider cone 118. In some embodiments, the inlet nozzles accelerates the gas to a fluid Mach number of 1. In some embodiments, the inlet nozzles can accelerate the gas to a fluid Mach number of 1 in an isentropic and adiabatic manner. Those skilled in the art having the benefit of this disclosure will appreciate that the isentropic and adiabatic aspects will not be 100% isentropic and adiabatic. Some amount of energy will be lost to friction and other sources. However, as a practical matter, the acceleration may be considered to be both isentropic and adiabatic. Note that the Mach number may vary depending on the particular application. Mach number values of 1 or less may be valuable for separating water vapor from compressed air while other applications may require a Mach number greater than 1.

The Mach number of 1 is proportional to the temperature of the fluid. The ambient environmental conditions may alter the temperatures experienced at the exit of the inlet nozzles with a speed of Mach 1. When adiabatically and isentropically converged and then diverged, the pressure and temperature of the gas drop in exchange for an increase in velocity, allowing vaporous fluids (e.g., water vapor) to condense.

When the system is in a transient phase from startup to steady state (often a system compressor will be intermittent, on and off), Mach will be less than 1. However, even with a Mach less than 1, the divider cone nozzle 122 does some amount of work as long as there is gaseous flow. Thus, although the intent of the divider cone nozzle 122 is to exceed Mach 1 and gain efficiency, the separator 120 can function at a lesser capacity with Mach less than 1 (e.g., Mach 0.9, 0.8, 0.7, 0.6, 0.5, 0.4, 0.3, 0.2, 0.1), and preferably not less than Mach 0.4. Some embodiments may therefore not accelerate the saturated gas to a supersonic speed, Mach 1 or greater, and thus operate with less efficiency.

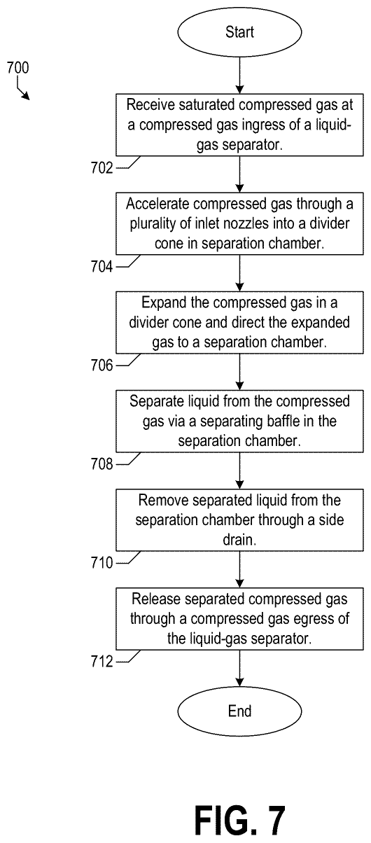

Thus far, a several specific embodiments of a liquid-gas separator that uses multiple inlet nozzles have been shown and described. Following now in FIG. 7 is a general method that may be used with a liquid-gas separator that uses multiple inlet nozzles in accordance with embodiments of the present disclosure. It should be noted that while FIG. 7 shows a number of discrete blocks, any of these blocks may be divided into several constituent blocks, or two or more of these blocks may be combined into a single block, or taken out of the sequence shown, without departing from the scope of the disclosed embodiments.

Referring to FIG. 7, a flow chart 700 is shown illustrating a method for separating liquid from a compressed gas in accordance with embodiments of the present disclosure. The method generally begins at 702, where saturated compressed gas is received in a liquid-gas separator at a compressed gas ingress thereof. In some embodiments, the compressed gas ingress may assume the form of an inlet plate. At 704, the compressed gas is accelerated through a plurality of inlet nozzles in the inlet plate into a divider cone within a separation chamber of the separator. The inlet nozzles may be formed within the inlet plate or mounted in the inlet plate, and each nozzle has an inner diameter and a length that are selected so as to accelerate the compressed gas to or below a dew point temperature thereof for a given type of gas under given pressure.

At 706, the compressed gas from the plurality of inlet nozzles expands out into the separation chamber, via a divider cone if present, such that the velocity of the gas decreases and moisture droplets/fog begin to form. At 708, the expanded gas passes through one or more separating baffles that are made of a mesh-like material in the separation chamber. The decrease in velocity of the expanded gas increases the contact time between the moisture droplets/fog and the one or more mesh-like separating baffles. The protracted moisture-to-mesh contact increases the moisture droplet size and facilitates formation of larger droplets and precipitation of the droplets along the wall of the expansion chamber 120.

At 710, separated liquid is drawn toward an inner wall of the separation chamber where it flows along the wall toward the compressed gas ingress and is subsequently removed through a side drain in the liquid-gas separator. In the meantime, at 712, separated gas continues to flow along its original course toward a compressed gas egress of the liquid-gas separator where it is released through the compressed gas egress. From the compressed gas egress, the separated gas may be provided to various compressed gas applications as needed or stored for subsequent use.

While particular aspects, implementations, and applications of the present disclosure have been illustrated and described, it is to be understood that the present disclosure is not limited to the precise construction and compositions disclosed herein and that various modifications, changes, and variations may be apparent from the foregoing descriptions without departing from the scope of the invention as defined in the appended claims.

What is claimed is:

1. A compressed gas and liquid separator, comprising:
a shell adapted to be vertically or horizontally oriented in use, the shell having an inlet end and an outlet end and defining a separating chamber therein;
an inlet plate coupled to the inlet end of the shell, the inlet plate providing a compressed gas ingress for receiving a flow of compressed gas into the separating chamber, the compressed gas including a liquid therein
a plurality of inlet nozzles disposed in the inlet plate, each inlet nozzle having an inner diameter and a length that are selected so as to accelerate the flow of compressed gas to or below a dew point thereof;
one or more separating baffles positioned within the separating chamber above the compressed gas ingress, the one or more separating baffles providing a means for separating the liquid from the compressed gas; and
an outlet plate coupled to the outlet end of the shell, the outlet plate providing a compressed gas egress out of the separating chamber.

2. The compressed gas and liquid separator of claim 1, further comprising a side drain disposed in the inlet plate proximate to the shell, the side drain facilitating removal of the separated liquid from the separating chamber.

3. The compressed gas and liquid separator of claim 1, wherein the plurality of inlet nozzles are arranged in a symmetrical pattern on the inlet plate.

4. The compressed gas and liquid separator of claim 1, wherein the plurality of inlet nozzles are formed in a multi-nozzle plate that is disposed in the inlet plate.

5. The compressed gas and liquid separator of claim 1, further comprising a divider cone coupled to the compressed gas ingress, the divider cone having a size and shape selected to accelerate the flow of compressed gas adiabatically and isentropically and direct the accelerated flow of compressed gas into the separating baffles.

6. The compressed gas and separator of claim 5, wherein the divider cone has a size and shape that are selected to accelerate the flow of compressed gas between Mach 0.1 and supersonic speed.

7. The compressed gas and separator of claim 1, wherein the plurality of inlet nozzles includes two or more inlet nozzles.

8. A method of separating gas and liquid, comprising:
providing a shell adapted to be vertically or horizontally oriented in use, the shell having an inlet end and an outlet end and defining a separating chamber therein;
receiving a flow of compressed gas into the separating chamber through a compressed gas ingress at the inlet end of the shell, the compressed gas including a liquid therein;
accelerating the flow of compressed gas through a plurality of inlet nozzles disposed at the compressed gas ingress, each inlet nozzle having an inner diameter and a length that are selected so as to accelerate the flow of compressed gas therethrough to or below a dew point thereof;
separating the liquid from the compressed gas at one or more separating baffles positioned within the separating chamber above the compressed gas ingress; and
providing a compressed gas egress out of the separating chamber at the outlet end of the shell.

9. The method according to claim 8, further comprising removing separated liquid from the separating chamber through a side drain disposed at the compressed gas ingress proximate to the shell, the side drain facilitating removal of the separated liquid from the separating chamber.

10. The method according to claim 8, further comprising arranging the plurality of inlet nozzles in a symmetrical pattern at the compressed gas ingress.

11. The method according to claim 8, wherein the plurality of inlet nozzles are formed in a multi-nozzle plate that is disposed within the compressed gas ingress.

12. The method according to claim 8, further comprising accelerating the flow of compressed gas through a divider cone at the compressed gas ingress, the divider cone having a size and shape selected to accelerate the flow of compressed gas adiabatically and isentropically and direct the accelerated flow of compressed gas into the separating baffles.

13. The method according to claim 12, wherein the divider cone has a size and shape that are selected to accelerate the flow of compressed gas between Mach 0.1 and supersonic speed.

14. The method according to claim 8, wherein the plurality of inlet nozzles includes two or more inlet nozzles.

15. A plate configured to provide an inlet for a compressed gas and liquid separator, the plate comprising:
a first inlet nozzle disposed in the plate for receiving a flow of compressed gas, the compressed gas including a liquid therein, the first inlet nozzle having an inner diameter and a length that are selected so as to accelerate the flow of compressed gas to or below a dew point thereof; and
at least one additional inlet nozzle disposed in the plate for receiving the compressed gas, each of the at least one additional inlet nozzle having an inner diameter and a length that are selected so as to accelerate the flow of compressed gas to or below the dew point thereof.

16. The plate of claim 15, wherein the first inlet nozzle and the at least one additional inlet nozzle are arranged in a symmetrical pattern on the plate.

17. The plate of claim 15, wherein the plate is a first plate, further comprising a second plate disposed in the first plate, wherein the first inlet nozzle and the at least one additional inlet nozzle are formed in the second plate.

18. The plate of claim 17, wherein the second plate has a larger thickness than the first plate, such that an annular moat is formed around the second plate.

19. The plate of claim 15, further comprising a side drain disposed in the plate proximate to an outer edge thereof, the side drain facilitating removal of liquid that has been separated from the compressed gas out through a side of the plate.

20. The plate of claim 15, wherein the at least one second inlet nozzle comprises two or more inlet nozzles.
